(19) United States
(12) Patent Application Publication
(10) Pub. No.: US 2008/0256981 A1
(43) Pub. Date: Oct. 23, 2008

(54) Method and Device for Treating Fibrous Wastes for Recycling

(75) Inventors: Remi Jacques, Estrees Saint-Denis (FR); Biagio Palmieri, Compiegne (FR); Stephane Maugendre, Precy Sur Oise (FR); Laurent Joubaud, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN ISOVER, Courbevoie (FR)

(21) Appl. No.: 11/572,620

(22) PCT Filed: Jul. 27, 2005
(86) PCT No.: PCT/FR05/50622

§ 371 Date: Oct. 19, 2007

(30) Foreign Application Priority Data
Jul. 29, 2004 (FR) 0451717

(51) Int. Cl. C03B 5/00

(52) U.S. Cl. 65/19

(57) ABSTRACT

The invention relates to a method for treating wastes, in particular from the production of mineral fibres such as fibreglass wool or rock fibres associated with organic binders and optionally with water or other metal and/or organic matters consisting in fusing a waste mass (9) by supplying a pure oxygen or an oxygen-enriched air in order to obtain a mineral material usable in the form of a vitreous raw material for glass melting and in inputting energy by means of at least one burner submerged under the waste mass (9). A device for carrying out said method is also disclosed.

The present invention relates to a method and a device for treating waste, particularly waste from mineral fiber production, for obtaining a mineral material useable as vitreous raw material in a glass melting process.

It relates more particularly to a method for treating waste from mineral fiber production, particularly of the fiberglass or rock wool type combined with organic binders and optionally with water or other metallic and/or organic materials.

The various steps in the production of mineral wool generate a certain quantity of waste. This waste may originate, for example, from cutting the products, and therefore it contains large quantities of organic matter, such as resins called “binders” that are used for the mechanical cohesion of fibrous mats, and optionally, large quantities of water. Other types of material may be combined with the mineral fibers, for example, paper films, based on aluminum or bituminous, elements of wooden pallets, etc.

The direct remelting of this waste in mineral wool production furnaces has proved to be unfeasible in practice because it presents many drawbacks. First, the fibrous structure of the mineral wool pad makes these products extremely thermally insulating, which is the reason for their use but also makes their melting difficult and very costly, in terms of time and energy. Due to their low density, the fibrous products also tend to float on the surface of the glass bath, making them difficult to incorporate. Furthermore, the large quantity of water and the high enthalpy of vaporization of this water incurs high energy costs, either directly in the furnace, or in an optional prior oven drying step. Finally, the high content of organic matter and hence of reducing agents, disturbs the glass melting and refining process, entailing the addition of large quantities of oxidizing agents such as sodium nitrate, thereby generating nitrogen oxide emissions detrimental to the environment, or manganese oxide, which risks unacceptably coloring the glass.

A method and a device suitable for recycling mineral wool waste by melting have been proposed in patent publication EP-A-0 389 314. They consist in conveying to the mass of fibrous waste pure oxygen or oxygen-enriched air (containing at least 40% oxygen) and in thereby causing the combustion of the organic binders, which, when the adiabatic temperature is sufficient, generates sufficiently intense heat to melt the mineral material. This method thus serves to separate the organic matter from the mineral materials (which can then be used as raw material in a melting furnace), generally without external supply of energy, because the heat is only provided by the combustion of the organic matter. In such a device, oxygen feeding means are placed on the hearth, under the waste heap.

During the industrial use of such a process, called the “Oxymelt” process, and to increase the specific output of such furnaces (the specific output is defined as the furnace output, expressed in tonnes of waste treated per day, related to the melt surface area in m²), it has proved necessary to supply part of the energy via overhead burners located above the waste heap. These burners nevertheless have the drawback of locally increasing the temperature of the furnace walls and roof, and hence the wear of the refractories forming these walls and this roof. Moreover, the glass formed is reduced (characterized by a high “redox” close to 1), entailing the use of oxidizing agents during its subsequent use as cullet (generally in contents up to 5 to 20% of the batch). The term “redox” means here the molar content of ferrous iron of the glass related to its total iron molar content. This term reflects the redox state of the glass, which strongly influences its physicochemical properties.

The present invention therefore proposes to improve this method, hence to increase its specific output without increasing the temperature of the walls and of the roof, and to lower the redox of the glass formed.

The primary subject of the invention is a method for treating waste, particularly waste from mineral fiber production, comprising a step for melting a waste mass by the input, to said waste mass, of pure oxygen or oxygen-enriched air through feeding means, in order to obtain a mineral material useable as batch material in a glass melting process, characterized in that energy is also added via at least one burner submerged under the waste mass and in that said means for feeding pure oxygen or oxygen-enriched air are placed on the support for said waste mass.

The waste is advantageously of the glass wool or rock wool fiber type combined with organic binders and optionally water or other metallic and/or organic materials. However, other types of waste combining at least partially vitrifiable mineral materials and organic matter may also be treated by the inventive method.

In the context of the invention, the expression “submerged burners” means here burners configured so that the flames they generate and the combustion gases produced develop within the very mass of materials being processed. Generally, they are positioned flush with or project slightly from the side walls or the hearth of the reactor used, and are aimed at the mass of materials to be processed. In the context of the present invention, the combustion gases are thereby discharged from at least one submerged burner into the waste mass, directly (the combustion gases are accordingly actually emitted inside the waste mass) and/or indirectly (the combustion gases are not emitted directly into the waste mass but develop later inside said mass). The term “burner” means here also a device supplying at least one oxidizer and at least one gaseous fuel in which, or directly after which, these reactants are blended in order to create an exothermic combustion reaction. This accordingly excludes devices sometimes termed burners although they supply only one or the other of the reactants (fuel or oxidizer).

The expression “means for feeding oxygen or oxygen-enriched air” means here devices, such as injectors, nozzles or more simply orifices, terminating in the waste mass and serving exclusively to supply said waste mass directly with pure oxygen or with oxygen-enriched air. Since the oxygen flows directly into the waste mass, the oxygen or oxygen-enriched air is thus fed directly into this very waste mass, permitting a uniform distribution of the oxidizing gas. These feeding means are therefore distinct from the submerged burners, the present invention using the combination of the two means, that is the means for feeding oxygen or oxygen-enriched air on the hand, and the or each submerged burner on the other. These feeding means are placed on the support of the waste mass to be treated, said support preferably being substantially horizontal.

The operating principle of a submerged burner furnace for glass melting is already known, and has been described particularly in documents WO 99/35099 and WO 99/37591: it consists in carrying out the combustion directly in the mass of batch materials to be melted, by injecting the fuel (generally gas of the natural gas type) and oxidizer (generally air or oxygen) via burners placed below the level of the melt, hence into the liquid glass bath. This type of submerged combustion causes, by convection, intensive mixing of the materials being melted, thereby permitting a rapid melting process.

The use of a submerged burner furnace for inerting waste is known from patent application WO 02/48612, but the recyling of fibrous materials by such a method is not considered therein. Submerged combustion in fact presupposes the presence of a glass bath in which the flame can develop. A person skilled in the art is therefore encouraged to believe that the addition of a burner actually into a heap of fibrous material will mainly generate strong flights and projections of fibers and considerable energy losses.

The inventors have nevertheless succeeded in demonstrating that the combination of at least one submerged burner with the oxygen feeding means of the “Oxymelt” type of device did not generate significant flights and also they significantly increased the specific output of the device, without major heat losses and while decreasing the quantity of oxygen necessary for melting.

A second particularly surprising advantage of the inventive method has been observed by the inventors. It turned out that an energy input via at least one submerged burner, instead of increasing the furnace temperatures, as may have been anticipated, decreases these temperatures on the contrary, thereby significantly lengthening the life of the furnace. The lower furnace temperature in fact has the advantage that the infiltration of glass into the interstices of the furnace refractories is lower, the infiltrated molten mass solidifying faster due to the lower temperature and plugging the interstices at a level closer to the furnace interior. It can be considered that this effect is a corollary of the effect of increasing the specific output: since the heap of fibrous materials is converted into molten material faster, the latter removes the energy faster. In the context of the inventive method, the melting temperature (measured at the furnace roof) is advantageously lower than 1200° C., even lower than or equal to 1150° C.

Obtaining such low temperatures can offer the possibility of constructing the furnace with less efficient and hence substantially cheaper refractory materials.

Moreover, this lowering of the temperature also has a direct beneficial effect of decreasing the redox of the glass formed. It is in fact known that high temperatures increase the stability of reduced species in the glass. By its implementation at lower temperatures, the inventive method thus serves to achieve the desired goal of oxidizing the glass.

Thanks to the use of at least one submerged burner, it is also no longer necessary to use overhead burners positioned above the heap of fibrous waste. Accordingly, the inventive method generally does not use such overhead burners.

The burners are preferably arranged in a zone substantially vertically below the top of the fibrous waste heap. They may, for example, be distributed symmetrically about a vertical access passing through the top of the heap of fibrous materials. They are advantageously at least two in number, or even three, and are selected preferably to make an odd number higher than one to distribute the power of the combustion gases at several points of the heap. The submerged burner(s) is/are thereby advantageously controlled in order to preserve the waste mass in the form of a stable heap above the burners. The presence of a single burner vertically below the top of the heap of fibrous materials risks, for example, having the consequence of destabilizing said heap, the burner possibly thereby being exposed, causing a poor transfer of heat to the fibrous waste and a possible overheating of the furnace roof and/or walls.

The burner geometry may be that described in patent document EP-A-0 966 406 or an equivalent geometry. The burner can thus be composed of a cooling system of the water box type and a central line fed with gaseous fuel of the natural gas type (or other gaseous fuel or fuel oil) around which one or more lines is/are concentrically arranged, supplied with oxidizer (for example oxygen), all these cylindrical section lines terminating in the burner nozzle.

The waste introduced generally consists of glass fibers possibly having a composition of the type described in document EP 412 878. The content of binding organic materials (resins) is generally about 5 to 10%, expressed as dry weight of the total weight of the fibers. They may contain a variable content of other materials (finishing films, packing materials, etc.).

A further subject of the invention is a device suitable for implementing the method described above.

This device is a furnace comprising a vessel consisting of refractory materials forming a hearth, walls and a roof, further comprising a support of the heap of fibrous waste on which are placed means for feeding pure oxygen or oxygen-enriched air, and at least one submerged burner placed on the hearth and/or on a wall. This support is preferably substantially horizontal.

In a first embodiment of the inventive device, the support of the waste may be the hearth of the furnace.

However, a second embodiment of the inventive device consists in supporting the fibrous waste by a grille located above the hearth. This grille is advantageously a grille of metallic material cooled by water circulation. It may, for example, consist of tubes comprising two cylindrical or concentric lines, one internal line fed with oxygen and one external line serving for cooling by water circulation, branch connections being placed at regular intervals in the internal line to supply the furnace with oxygen. An input of pure oxygen or oxygen-enriched air directly into the waste mass is thereby guaranteed. In implementing the method using this embodiment of the inventive device, the hot gases issuing from the merged combustion contribute to the melting of the heap of fibrous waste, the molten materials accordingly flowing between the meshes of the grille to form a glass bath in which the flames of the submerged burners develop. An additional advantage associated with the use of this particular device resides in the fact that the redox of the glass formed and collected in the bath is controllable by the stoichiometry of the flame, at least one submerged burner. The more or less oxidizing nature of the flame may, in effect, be directly controlled by adjusting the proportion of oxidizer (generally oxygen) in relation to that of the fuel (for example methane, also called “natural gas”). When the oxidizer is oxygen (O₂) and the fuel is methane (CH₄), the O₂/CH₄ mole ratio is preferably higher than or equal to 2, particularly higher than or equal to 2.1, or even to 2.2, in order to guarantee a reduction of the redox.

The glass formed can particularly be much more oxidized than in the embodiment in which the hearth is the support of the heap of fibrous waste. Without being bound by any scientific theory whatsoever, it is conceivable that the presence of a glass bath, in which the residence time of the glass is high, enables the glass to reach a thermodynamic equilibrium imposed by the combustion gases of the submerged burner(s). In the case in which the hearth of the furnace is the support of the fibrous waste heap, the residence time of the molten materials is probably very short due to the virtual absence of a glass bath, and both the more or less oxidizing nature of the submerged flames and the oxidizing nature of the oxygen introduced into the furnace at the level of the hearth play a lesser role on the redox state of the final glass.

The present invention will be better understood from a reading of the detailed description below of nonlimiting exemplary embodiments illustrated by the figures appended hereto:

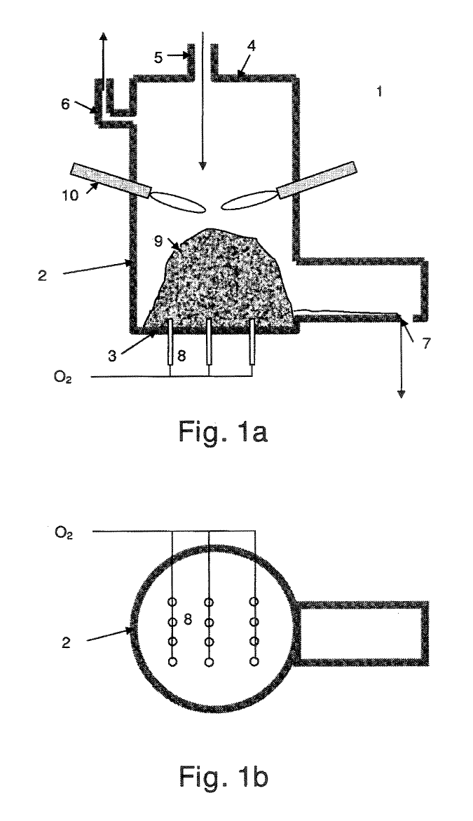

FIGS. 1a and 1b illustrate cross sections along respectively vertical and horizontal planes of a device for implementing the “Oxymelt” process as described by patent document EP-A-0 389 314.

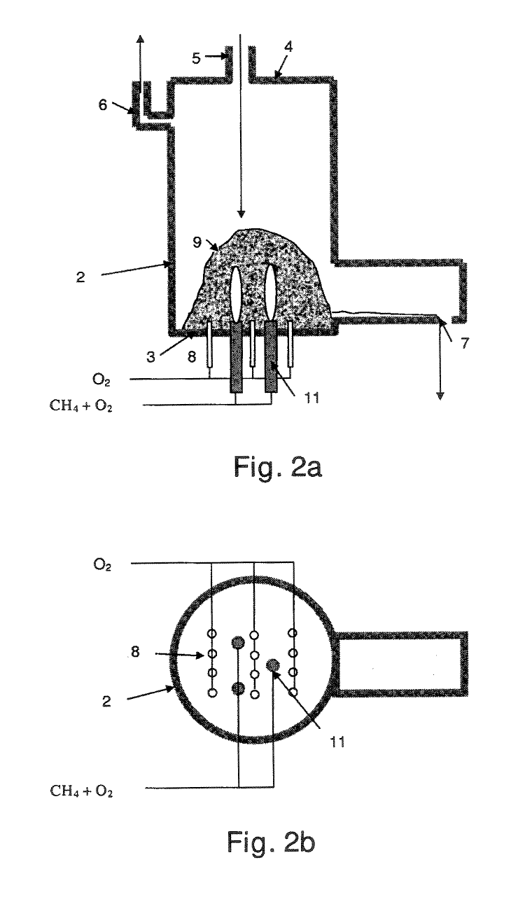

FIGS. 2a and 2b illustrate cross sections along respectively vertical and horizontal planes of an embodiment of the device for implementing the inventive method.

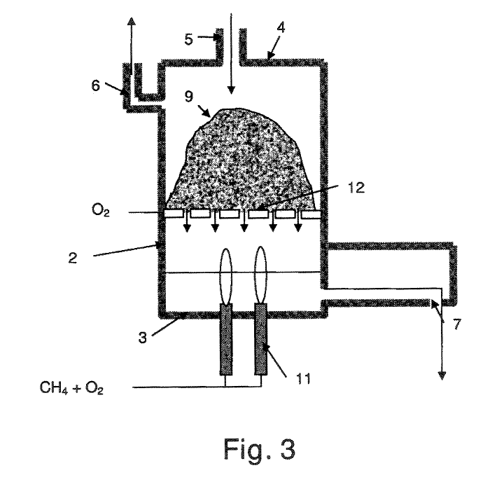

FIG. 3 illustrates a cross section along a vertical plane of the second embodiment of the device for implementing the inventive method.

FIGS. 1a and 1b show the device known from EP-A-0 389 314. The device 1 comprises a cylindrical vessel constructed of refractory materials consisting of walls 2, a hearth 3 and a roof 4. The device 1 also comprises a charging zone 5, a stack 6 for extracting the flue gases to a pollution control device not shown, a furnace outlet 7 comprising a channel in the lower part whereof is placed an orifice for pouring the molten materials, pure oxygen (or oxygen-enriched air) injectors 8 placed on the hearth 3 of the furnace (said hearth serving as a horizontal support of the heap of fibrous waste) and two overhead burners 10.

This device serves to implement a continuous method defined by the following steps:
the waste is introduced via the charging zone 5 using a feed screw with a diameter of 50 cm in the form of coarsely crushed materials comprising glass wool fibers and mixed with organic or inorganic products such as synthetic resins based on phenol and formaldehyde acting as binder, paper or aluminum films, etc., and forming a heap 9 on the hearth 3 of the furnace,
the oxygen injectors 8 supply the oxidizer which reacts exothemically with the fuel formed by the organic part of the waste. In the case in which the adiabatic temperature is higher than 1200° C., the heat liberated by the reaction is insufficient to melt the fibrous materials. The overhead burners 10 are also in operation to increase the output of the device thanks to an additional energy input,
the fibrous mass thus gives rise to a molten mass which trickles in the form of a thin film having a viscosity of 100 to 1000 poise to the outlet 7 of the furnace to flow into the flow orifice provided at the base of said outlet 7,
simultaneously, the combustion gases and flue gases are extracted via the stack 6.

Such an industrial device has a surface area of 3 m² capable of heating 18 tonnes of waste from glass wool production daily, thanks to an oxygen input of 250 Sm³ per hour, and an energy input of 200 kW via the two overhead burners 10. The furnace temperature (measured at the roof) during normal operation is 1230° C.

FIGS. 2a and 2b show one embodiment of the inventive device. The overhead burners 10 are no longer present here. However, three submerged burners 11 are placed on the hearth 3 of the furnace. These three burners 11 are substantially arranged symmetrically about a vertical axis passing through the top of the heap of fibrous materials 9. They are supplied with methane and oxygen, in a stoichiometric ratio, and the combustion gases (that is the combustion reaction products) are emitted and develop within the waste mass.

The invented device serves to implement a method which is different from the method known from document EP-A-0 389 314, and described above, in the absence of an energy input via overhead burners 10 and in the step in which the submerged burners serve to increase the specific output while decreasing the operating temperatures.

In the context of the present invention, the addition of the three submerged burners 11, placed on the hearth 3 of the furnace, serves to increase the quantity of waste treated to 24 tonnes per day, representing an increase of about 33%, for a power input of 240 kW. Since the overhead burners are no longer used, the energy consumption has only increased slightly compared with the improved device. However, the furnace temperature has sharply decreased, falling from 1230° to 1150° C. The oxygen consumption has decreased by 30%.

Knowing the content of combustible materials in the waste introduced, and the efficiency of the furnace in this given operating mode, the furnace can be controlled by adjusting the oxygen content of the flue gases leaving the furnace, which can be measured in a flue gas discharge zone. In the embodiment shown here, the oxygen content of the flue gases is regulated at 15% by volume.

FIG. 3 illustrates a second embodiment of the inventive device. The heap of fibrous waste 9 is supported here by a metal grille 12 allowing the flow of the molten materials. This grille 12 also replaces the injectors 8 in that it constitutes the means for supplying oxygen for the combustion of the organic products present in the waste. In this embodiment of the inventive method, the submerged burners 11 discharge at a certain distance below the bottom level of the heap, so that a glass bath is located above the submerged burners 11. The combustion gases are therefore not emitted directly into the waste mass, but develop later within said mass. The residence time of the glass in this device can be substantially increased compared with the first embodiment, whereof the implementing device is illustrated by FIG. 2 and the redox of the glass can be adjusted by changing the O₂/CH₄ molar ratio.

1-14. (canceled)

15: A method for treating waste to obtain a mineral material useable as a vitreous raw material in a glass melting process, comprising a step for melting a waste mass by the input, to said waste mass, of pure oxygen or oxygen-enriched air through feeding means, characterized in that energy is also added via at least one burner submerged under the waste mass, said burner being a device supplying at least one oxidizer and at least one gaseous fuel in which, or directly after which, these reactants are blended in order to create an exothermic combustion reaction and in that said means for feeding pure oxygen or oxygen-enriched air are placed on the support for said waste mass, said waste being of the glass wool or rock wool fiber type combined with organic binders and optionally water or other metallic and/or organic materials.

16: The method as claimed in claim 15, characterized in that the melting step uses an input of oxygen-enriched air containing at least 40% oxygen.

17: The method as claimed in claim 15, characterized in that the combustion gases are discharged from at least one burner directly submerged in said waste mass.

18: The method as claimed in claim 15, characterized in that said submerged burner(s) is/are controlled in order to preserve the waste mass in the form of a stable heap above the burners.

19: A device for implementing the method as claimed in claim 15, characterized in that it comprises a vessel built of refractory materials forming a hearth (3), walls (2) and a roof (4), a support (3, 12) for the heap of fibrous waste (9) on which means for feeding pure oxygen or oxygen-enriched air (8) are placed, and at least one submerged burner (11) placed on the hearth (3) and/or on a wall (2), said burner being a device supplying at least one oxidizer and at least one gaseous fuel in which, or directly after which, these reactants are blended in order to create an exothermic combustion reaction.

20: The device as claimed in claim 19, characterized in that said support for the heap of fibrous waste (9) consists of the hearth (3) of said device.

21: The device as claimed in claim 19, characterized in that said burners (11) are arranged in a zone substantially vertically below the top of the heap of fibrous waste.

22: The device as claimed in the claim 21, characterized in that said burners (11) are distributed symmetrically about a vertical axis passing through the top of the heap of fibrous materials.

23: The device as claimed in the claim 22, characterized in that said burners are at least three in number and their total makes an odd number.

24: The device as claimed in claim 19, characterized in that said support for the heap of fibrous waste (9) consists of a grille (12) located above the hearth (3).

25: The device as claimed in claim 24, characterized in that said grille (12) is made from a metallic material cooled by water circulation.

26: The device as claimed in claim 25, characterized in that said grille (12) consists of tubes comprising two cylindrical and concentric lines, one internal line fed with oxygen and one external line used for cooling by water circulation, branch connections being placed at regular intervals in the internal line to supply the furnace with oxygen.

27: The device as claimed in claim 19, characterized in that said burner(s) (11) is/are composed of a cooling system of the water box type and a central line supplied with gaseous fuel around which one or more lines are placed concentrically, supplied with oxidizer or oxygen, all of these cylindrical section lines terminating in the burner nozzle.
